(19) United States
(12) Patent Application Publication
(10) Pub. No.: US 2015/0371056 A1
(43) Pub. Date: Dec. 24, 2015

(54) SYSTEM AND METHOD FOR ENHANCING USABILITY OF APPLICATIONS RUNNING ON DEVICES THAT SECURELY STORE DATA

(71) Applicant: INFOSYS LIMITED, Bangalore (IN)

(72) Inventors: Venkat Kumar Sivaramamurthy, Bangalore (IN); Puneet Gupta, Bangalore (IN)

(73) Assignee: INFOSYS LIMITED, Bangalore (IN)

(21) Appl. No.: 14/719,135

(22) Filed: May 21, 2015

(30) Foreign Application Priority Data
Jun. 23, 2014 (IN) 3028/CHE/2014

(51) Int. Cl. G06F 21/62; H04L 29/08; H04L 29/06

(52) U.S. Cl. CPC G06F 21/6218; H04L 67/42; H04L 67/1097

(57) ABSTRACT

The technique relates to a system and method for enhancing usability of devices that securely store data. The method involves receiving a plurality of client related context information from a client on a server, in response to invocation of a client application on a device then obtaining data and a plurality of data related context information from the server thereafter determining decision on data storage request on the device based on the client related context information and the data related context information and finally communicating the data and the decision to the client.

### FIELD

The field generally relates to an enhanced usability of applications running on devices and more, particularly, a system and method for enhancing usability of applications running on devices that securely store data.

### BACKGROUND

The usability of applications running on devices are impacted by various factors and type of hardware. The hardware configuration impacts the processing time of various encryption/decryption algorithm based on the algorithm and key size hence in low configuration hardware a specific algorithm with a larger key size takes more time to encrypt/decrypt the local data impacting the usability. In current scenario there is same level of security is available for any type of hardware.

In view of foregoing discussion, there is a need of system and method for enhancing usability of devices that securely store data to enables the secure store of local data based on the underlying device capability without impacting the usability and in a scenario wherein the underlying hardware cannot meet the usability requirement, storage of local data is not enabled for those services. Hence providing a stringent level of data security in light of hardware configuration also.

### SUMMARY

The present invention overcomes the limitation mentioned above by providing a system and method for enhancing usability of applications running on devices that securely stores data.

According to present embodiment, a method for enhancing usability of applications running on devices that securely store data is disclosed. A plurality of client related context information is received from a client on a server, in response to invocation of a client application on a device then data and a plurality of data related context information is obtained from the server thereafter a decision on data storage request on the device is obtained based on the client related context information and the data related context information and finally the data and the decision is communicated to the client.

In an additional embodiment, a system for enhancing usability of applications running on devices that securely store data is disclosed. The system includes a client related context information receiving component, a data and data related context information obtaining component, a decision component and a communication component. The client related context information receiving component configured to receive a plurality of client related context information from a client on a server, in response to invocation of a client application on a device. The data and data related context information obtaining component configured to obtain data and a plurality of data related context information from the server. The decision component configured to determine a decision on data storage request on the device based on the client related context information and the data related context information. The communication component configured to communicate the data and the decision to the client.

In another embodiment, a non-transitory computer readable medium for enhancing usability of applications running on devices that securely store data is disclosed. This involves a non-transitory computer readable medium having stored thereon instructions for enhancing usability of devices that securely store data by receiving, a plurality of client related context information from a client on a server, in response to invocation of a client application on a device thereafter obtaining, data and a plurality of data related context information from the server then determining, a decision on data storage request on the device based on the client related context information and the data related context information and finally communicating the data and the decision to the client.

### DRAWINGS

Various embodiments of the invention will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein.

FIG. 2 is a flowchart illustrating a method for enhancing usability of devices that securely store data, in accordance with an embodiment of the present technique.

FIG. 3 is a block diagram illustrating a system for enhancing usability of devices that securely store data, in accordance with an embodiment of the present technique.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

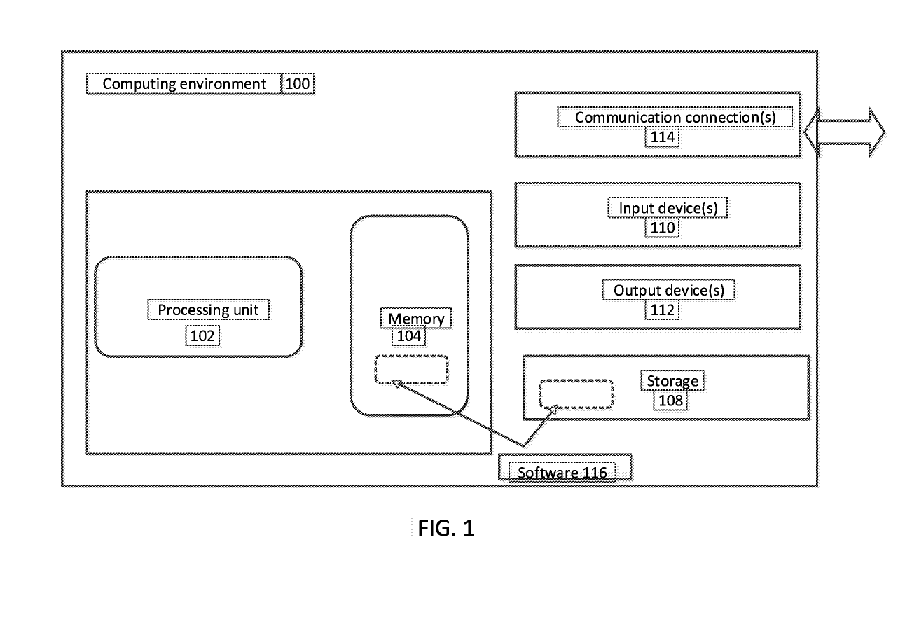

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

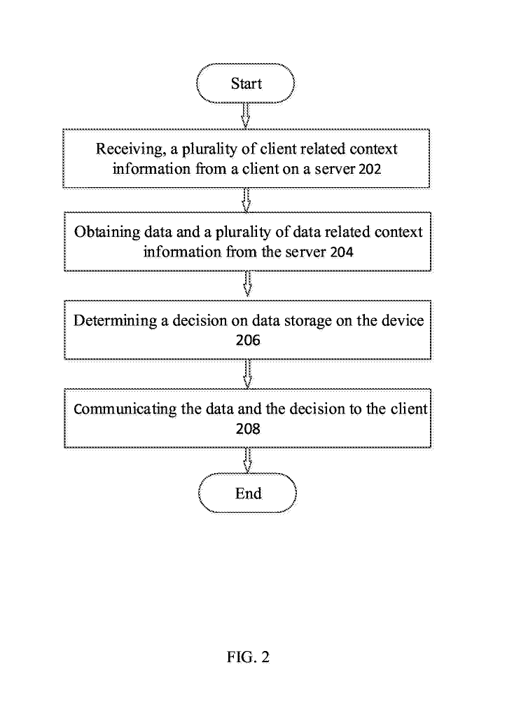

FIG. 2 is a flowchart, illustrating a method for enhancing usability of applications running on devices that securely store data, in accordance with an embodiment of the present technique. A plurality of client related context information from a client on a server is received, in response to invocation of a client application on a device 202 then data and a plurality of data related context information is obtained from the server 204 thereafter a decision on data storage request on the device is obtained based on the client related context information and the data related context information 206 and finally the data and the decision is communicated to the client 208. The decision on data storage request involves accepting or rejecting the data storage request on the device. The client related context information is not limited to hardware or memory related information, location information, client or user or customer information etc. Based on the client related context information, the client device is classified as low, medium or high end device. The plurality of data related context information involves plurality of information on required encryption algorithm, required key size for the data storage and a sensitivity level of data. The data involves information of the client required to perform a transaction requested by the client. The data may be from an enterprises who is hosting the client application. The data and the plurality of data related context information obtained from the server. The decision on the data storage request is taken based on the client related context information and the data related context information. The data sensitivity levels are low sensitivity data, medium sensitivity data or high sensitivity data.

In a case wherein the data storage request on the device has been rejected in such scenario the data may be stored at alternate location but not limited to external memory, cloud etc.

An enterprise or appropriate entity may host the client application. According to an exemplary embodiment an enterprise is a bank which is providing multiple financial services to the client (may referred as user or customer) in order to avail various online services offered by the enterprise, the client may use the client application provided by the bank (e.g. Mobile Banking) to perform financial transaction such as downloading account statements, account information etc. In response to an invocation of an application by the client wherein the client has requested to download the account statement of his account. In order to perform the requested transaction a plurality of client related context information is received from server wherein the information involves memory information of device which client is using (also referred as client device, may be as low, medium or high end device), location of the client, processor information etc. thereafter data and plurality of data related context information is obtained from a server, the data is account statement according to an exemplary embodiment of the invention wherein the data sensitivity levels may be low sensitivity data, medium sensitivity data or high sensitivity data classified by the enterprise or any other suitable entity. The plurality of data related context information involves the information on required encryption algorithm, required key size for the data storage and a sensitivity level of data etc. Finally a decision on data storage request on the device based on the client related context information and the data related context information is determined. The device is not limited to desktop, laptop, hand-held device, mobile device, PDA, touch or non-touch devices.

According to another exemplary embodiment of the invention following exemplary decisions are taken device based on the client related context information and the data related context information:

For low grade device, the data is not stored and fetched from the remote server every time.

For medium grade device, the data tagged with low to medium sensitivity is stored encrypted and fetched locally, decrypted and used.

For high grade device, all kind of data is stored encrypt and fetched locally, decrypted and used.

However, all above rules are configurable based on the type of enterprise business or business requirements, or any other relevant factors. The enterprise is not limited to banks, financial institutes, companies, organizations etc.

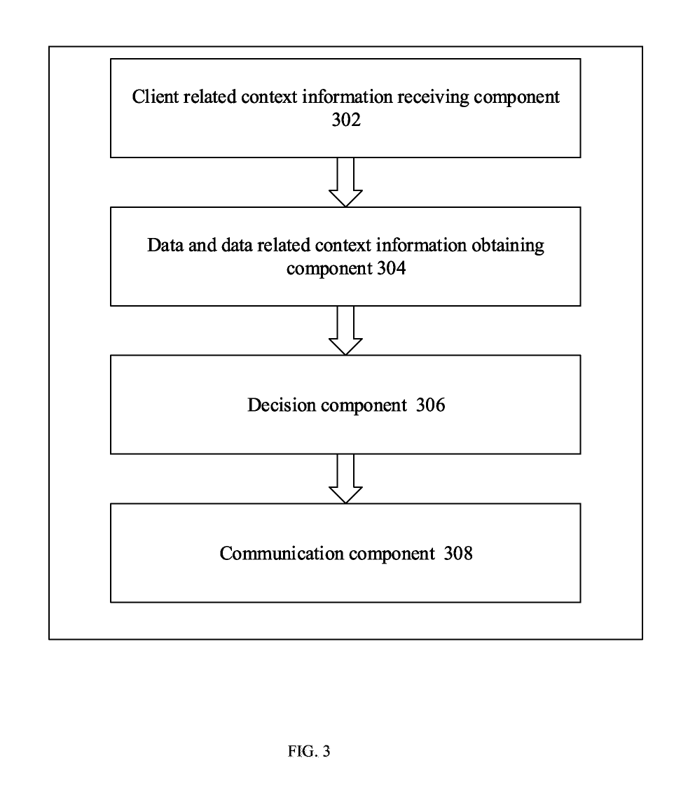

FIG. 3 is a block diagram illustrating a system for enhancing usability of devices that securely store data, in accordance with an embodiment of the present technique. The system includes a client related context information receiving component 302, a data and data related context information obtaining component 304, a decision component 306 and a communication component 308. The client related context information receiving component configured to receive a plurality of client related context information from a client on a server, in response to invocation of a client application on a device. The data and data related context information obtaining component configured to obtain data and a plurality of data related context information from the server. The decision component configured to determine a decision on data storage on the device based on the client related context information and the data related context information. The communication component configured to communicate the data and the decision to the client.

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

We claim:

1. A computer implemented method for enhancing usability of devices that securely store data comprising:
receiving, by a processor, a plurality of client related context information from a client on a server, in response to invocation of a client application on a device;
obtaining, by the processor, data and a plurality of data related context information from the server;
determining, by the processor, a decision on data storage request on the device based on the client related context information and the data related context information; and
communicating, by the processor, the data and the decision to the client.

2. The method as claimed in claim 1, wherein determining the decision on data storage request involves accepting or rejecting the data storage request on the device.

3. The method as claimed in claim 2, further comprising:
storing, by the processor, the data at alternate location in a case wherein the data storage on the device is rejected.

4. The method as claimed in claim 1, wherein the plurality of data related context information involves plurality of information on required encryption algorithm, required key size for the data storage and a sensitivity level of data.

5. The method as claimed in claim 4, wherein the data sensitivity levels are low sensitivity data, medium sensitivity data or high sensitivity data.

6. A system for enhancing usability of devices that securely store data comprising:
a processor in operable communication with a processor readable storage medium, the processor readable storage medium containing one or more programming instructions whereby the processor is configured to implement:
a client related context information receiving component configured to receive a plurality of client related context information from a client on a server, in response to invocation of a client application on a device;
a data and data related context information obtaining component configured to obtain data and a plurality of data related context information from the server;
a decision component configured to determine a decision on data storage request on the device based on the client related context information and the data related context information; and
a communication component configured to communicate the data and the decision to the client.

7. The system as claimed in claim 6, wherein determining the decision on data storage request involves accepting or rejecting the data storage request on the device.

8. The system as claimed in claim 7, further comprising:
a storage component configured to store the data at alternate location in a case wherein the data storage request on the device is rejected.

9. The system as claimed in claim 6, wherein the plurality of data related context information involves plurality of information on required encryption algorithm, required key size for the data storage and a sensitivity level of data.

10. The system as claimed in claim 9, wherein the data sensitivity levels are low sensitivity data, medium sensitivity data or high sensitivity data.

11. A non-transitory computer readable medium having stored thereon instructions for enhancing usability of devices that securely store data comprising machine executable code which when executed by at least one processor, causes the at least one processor to perform steps comprising:
receiving a plurality of client related context information from a client on a server, in response to invocation of a client application on a device;
obtaining data and a plurality of data related context information from the server;
determining a decision on data storage request on the device based on the client related context information and the data related context information; and
communicating the data and the decision to the client.

12. The non-transitory computer readable media as in claim 11, wherein determining the decision on data storage request involves accepting or rejecting the data storage request on the device.

13. The non-transitory computer readable media as in claim 12, where in the steps further comprise:
storing, by the processor, the data at alternate location in a case wherein the data storage request on the device is rejected.

14. The non-transitory computer readable media as in claim 11, wherein the plurality of data related context information involves plurality of information on required encryption algorithm, required key size for the data storage and a sensitivity level of data.

15. The non-transitory computer readable media as in claim 14, wherein the data sensitivity levels are low sensitivity data, medium sensitivity data or high sensitivity data.
